(19) United States
(12) Patent Application Publication
(10) Pub. No.: US 2005/0077952 A1
(43) Pub. Date: Apr. 14, 2005

(54) Band gap constant voltage circuit

(75) Inventor: Hiroshi Okada, Nukata-gun (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/916,559

(22) Filed: Aug. 12, 2004

(30) Foreign Application Priority Data
Oct. 14, 2003 (JP) 2003-353763

(51) Int. Cl. G05F 1/10

(52) U.S. Cl. 327/539

(57) ABSTRACT

Transistors and a temperature correcting resistive element are formed in the same silicon substrate to constitute a bipolar monolithic integrated circuit. A band gap constant voltage circuit has npn type bipolar transistors whose bases are commonly connected to each other, and generates a reference voltage in connection with a base-emitter voltage of each of the transistors. A temperature correcting resistive element formed of a diffusion resistor having temperature non-linearity is connected in series to a resistive element through which the collector current of each of the transistors flows.

### CROSS REFERENCE TO RELATED APPLICATION

This application is based upon, claims the benefit of priority of, and incorporates by reference the contents of Japanese Patent Application No. 2003-353763 filed on Oct. 14, 2003.

### FIELD OF THE INVENTION

The present invention relates to a band gap constant voltage circuit (band gap regulator, band gap reference circuit).

### BACKGROUND OF THE INVENTION

Band gap regulators including first and second bipolar transistors with commonly-connected bases that output a reference voltage in connection with the base-emitter voltages of the first and second bipolar transistors are known. (See, for example, JP-A-2000-339049 (pp 2-3, FIG. 3), hereinafter referred to as “Patent Document 1”).

FIG. 9 is a circuit diagram showing the construction of a related art band gap constant voltage circuit 78 achieved by altering a portion of a band gap regulator disclosed in FIG. 3 of Patent Document 1. The band gap constant voltage circuit 78 comprises resistive elements R11 to R18, npn type bipolar transistors Q11, Q12, Q17, Q18, pnp type bipolar transistors Q15, Q16, a diode D11 and a capacitor C2. The band gap constant voltage circuit 78 is connected to a positive side power supply (not shown) to be supplied with a power supply potential Vcc to set the voltage at a node N11 to a reference voltage Vo (constant voltage). The reference voltage Vo is subjected to voltage division by the resistive elements R15 and R16 to achieve a desired constant voltage at a node N12, and the desired constant voltage (OUT) at the node N12 is output to the external. In the circuit disclosed in FIG. 3 of the Patent Document 1, the reference voltage Vo is output to the external. On the other hand, the circuit shown in FIG. 9 is different from the circuit of the Patent Document 1 in that the voltage OUT of the node N12 is output to the external.

Also known is a band gap reference circuit comprising first and second diodes having cathodes connected to a ground terminal, a first resistive element connected to the anode terminal of the first diode and a first terminal, a third resistive element connected to the anode terminal of the second diode and a second terminal, a second resistive element connected to the first terminal and the second terminal, and a feedback circuit for controlling the voltage of the first terminal so that the potential of the anode terminal of the first diode is equal to the potential of the second terminal. (See for example, JP-A-2001-202147 (page 3, FIG. 13), hereinafter referred to as “Patent Document 2”).

Also known is a constant voltage circuit that includes a first transistor having a collector and base connected to each other, a second transistor which has an emitter area that is proportional to the first transistor by an integer value and that has a base connected to the base of the first transistor and an emitter connected to one end of a power supply terminal through a first resistive element, a third transistor having a base connected to the collector of the second transistor, a second resistive element connected between the collector of the second transistor and an output terminal, and a third resistive element connected between the collector of the first transistor and the output terminal, the emitter of the first transistor being connected to one end of the power supply terminal while the emitter of the third transistor is connected to one end of the power supply terminal. (See, for example, JP-A-6-110573 (page 2, FIG. 3), hereinafter referred to as “Patent Document 3”).

Various names are used for a circuit for achieving a constant voltage by using a band gap of a transistor. In the following description, “band gap constant voltage circuit” is used. Furthermore, a constant voltage generated by the band gap constant voltage circuit will be referred to as “reference voltage”.

In the band gap constant circuits disclosed in Patent Documents 1 to 3 discussed above, temperature non-linearity occurs in a generated reference voltage due to temperature characteristics of transistors constituting the circuit, a circuit structure, etc.

For example, in the circuit of the Patent Document 1, a reference voltage Vo at a room temperature of 25° C. is equal to 1.230V. However, the reference voltage Vo varies from 1.227 to 1.230V when the ambient temperature of the circuit varies from −40 to 120° C. as shown in FIG. 10, so that the temperature variation of the reference voltage Vo ranges from 1.5 to 3 mV.

Recently, an accurate reference voltage that does not depend on temperature in a broad temperature range has been required for electronic circuits. Therefore, it has also been required that the temperature non-linearity of a reference voltage in a broad temperature range is improved in band gap constant circuits frequently used as a reference voltage source.

Patent Document 2 discloses a technique of equipping an adjusting circuit for adjusting a linear inclination of a reference voltage to temperature. However, it is impossible in the technique disclosed in the Patent Document 2 to adjust the temperature non-linearity of the reference voltage in the broad temperature range as shown in FIG. 10. In addition, the Patent Document 2 neither describes nor suggests the temperature non-linearity of the reference voltage.

### SUMMARY OF THE INVENTION

The present invention has been implemented in order to solve the foregoing problem, and has an object to provide a band gap constant voltage circuit which can improve temperature non-linearity of a reference voltage in a broad temperature range.

According to a first aspect of the present invention, a band gap constant voltage circuit for generating a constant voltage serving as a reference voltage on the basis of a band gap voltage based on pn junction of a semiconductor element is characterized in that a temperature correcting resistive element having temperature non-linearity which offsets (corrects) the temperature non-linearity of the reference voltage is connected to a current setting resistive element for setting current flowing in the semiconductor element in series.

According to a second aspect of the present invention, a band gap constant voltage circuit including first and second bipolar transistors, a current mirror circuit for equalizing collector current between the first and second bipolar transistors, and a current setting resistive element for setting the collector current of the first and second bipolar transistors, a constant voltage serving as a reference voltage being generated from commonly-connected bases of the first and second bipolar transistors on the basis of a band gap voltage based on pn junction between the base and emitter of the first and second bipolar transistors, is characterized in that a temperature correcting resistive element having temperature non-linearity which offsets the temperature non-linearity of the reference voltage is connected to the current setting resistive element in series.

According to a third aspect of the present invention, in the band gap constant voltage circuit of the first or second aspect of the present invention, the temperature correcting resistive element comprises a diffusion resistive element using a diffusion layer formed in the same semiconductor substrate as the semiconductor element.

According to a fourth aspect of the present invention, the band gap constant voltage circuit of any one of the first to third aspects is characterized by further comprising adjusting means for adjusting the resistance values of the current setting resistive element and the temperature correcting resistive element.

According to the first or second aspect of the present invention, the temperature correcting resistive element having temperature non-linearity which offsets the temperature non-linearity of the reference voltage is connected to the current setting resistive element in series, and the temperature linearity of the temperature correcting resistive element is suitably set, whereby the temperature non-linearity of the reference voltage in the broad temperature range an be improved.

According to the third aspect of the present invention, the temperature correcting resistive element is implemented by the diffusion resistive element formed in the same semiconductor substrate as the semiconductor element or the transistor, so that the temperature correcting resistive element which can surely correct the temperature non-linearity of the reference voltage can be easily achieved.

According to the fourth aspect of the present invention, the temperature non-linearity of the reference voltage can be set to a desired value by adjusting the resistance values of the current setting resistive element and the temperature correcting resistive element with the adjusting means.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing the construction of a band gap constant voltage circuit according to a first embodiment;

FIG. 2 is a graph showing temperature non-linearity of each of a reference voltage Vo of a related art band gap constant voltage circuit shown in FIG. 9 and a reference voltage Vo of a band gap constant voltage circuit of the first embodiment;

FIG. 3 is a circuit diagram showing the construction of a band gap constant voltage circuit according to a second embodiment;

FIG. 4 is a circuit diagram showing the construction of a band gap constant voltage circuit according to a third embodiment;

FIG. 5 is a circuit diagram showing the construction of a band gap constant voltage circuit according to a fourth embodiment;

FIG. 6 is a circuit diagram showing the construction of a band gap constant voltage circuit according to a fifth embodiment;

FIG. 7 is a circuit diagram showing the construction of a band gap constant voltage circuit according to a sixth embodiment;

FIG. 8 is a circuit diagram showing the construction of a band gap constant voltage circuit according to a seventh embodiment;

FIG. 9 is a circuit diagram showing the construction of a related art band gap constant voltage circuit (band gap regulator); and

FIG. 10 is a graph showing temperature non-linearity of a reference voltage Vo of the related art band gap constant voltage circuit shown in FIG. 9.

### DESCRIPTION OF THE PREFERRED EMBODIMENTS

Preferred embodiments according to the present invention will be described hereunder with reference to the accompanying drawings.

### First Embodiment

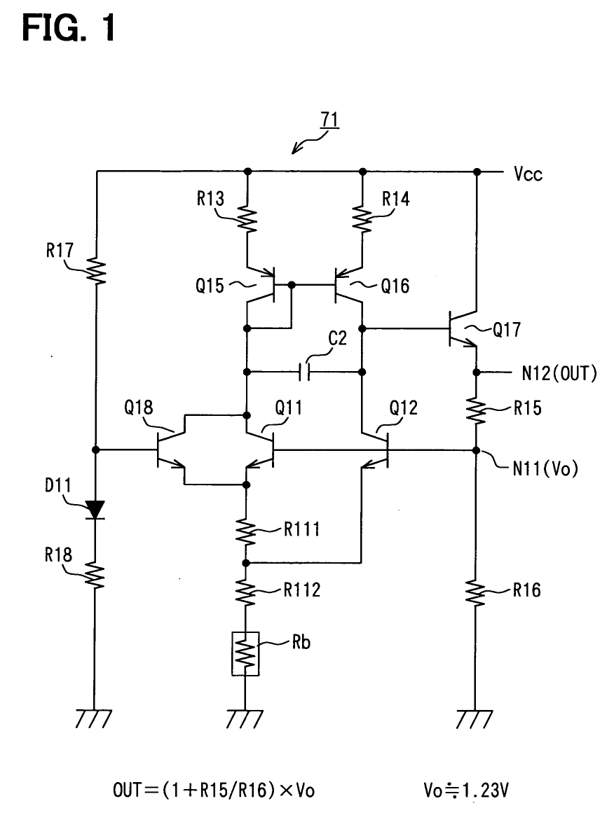

FIG. 1 is a circuit diagram showing the construction of a band gap constant voltage circuit 71 according to a first embodiment of the present invention.

The band gap constant voltage circuit 71 comprises resistive elements R13 to R18, R111, R112, npn type bipolar transistors Q11, Q12, Q17, Q18, pnp type bipolar transistors Q15, Q16, a diode D11, a capacitor C2 and a temperature correcting resistive element Rb. The band gap constant voltage circuit 71 is connected to a positive side power supply (not shown) to be supplied with a power supply potential Vcc, so that the voltage at a node N11 is set to a constant voltage, i.e., a reference voltage Vo (≅1.23V). Further, the reference voltage Vo is subjected to resistance division by the resistive elements R15 and R16 to achieve a desired constant voltage at a node N12. The desired constant voltage (OUT) at the node N12 is output to the external (OUT=(1+R15/R16)×Vo).

The power supply potential Vcc is applied to one end of each of the resistive elements R13 and R14, which have resistance values that may be set to be equal to each other, for example. The other end of the resistive element R13 is connected to the emitter of the diode-connected pnp bipolar transistor Q15. The other end of the resistive element R14 is connected to the emitter of the pnp type bipolar transistor Q16.

The characteristics of the transistors Q15 and Q16 are mutually equal to one another. The respective bases of the transistors Q15 and Q16 are mutually connected to each other to thereby constitute a current mirror circuit. The current mirror circuit serves to equalize collector current between the transistors Q11 and Q12. A capacitance element (capacitor) C2 for preventing parasitic oscillation is connected between the collectors of the transistors Q15 and Q16.

The collector of the transistor Q15 is connected to the collector of the npn type bipolar transistor Q11, and the collector of the transistor Q16 is connected to the collector of the npn type bipolar transistor Q12. The resistive elements R111, R112, Rb are successively connected to the emitter of the transistor Q11 in series in this order, and the other end of the temperature correcting resistive element Rb is grounded. The emitter of the transistor Q12 is connected to a node between the resistive elements R111 and R112.

The power supply potential Vcc is applied to the collector of the transistor Q17, and the base of the transistor Q17 is connected between the transistors Q16 and Q12. The resistive elements R15, R16 are connected to the emitter of the transistor Q17 in series, and the other end of the resistive element R16 is grounded. The bases of the transistors Q11, Q12 are connected to a node N11 between the resistive elements R15, R16.

A start-up circuit comprising resistive elements R17 and R18, a diode D11 and a transistor Q18 is connected to the band gap constant voltage circuit 71. The resistive element R17, the diode D11 and the resistive element R18 are connected in this order between the positive side power supply and the ground, and the power supply potential Vcc is applied to one end of the resistive element R17. The base of the transistor Q18 is connected between the resistive element R17 and the diode D11. The emitter and collector of the transistor Q18 are connected to the emitter and collector of the transistor Q11, respectively.

The transistors Q11 to Q16 and the temperature correcting resistive element Rb are constructed by bipolar monolithic integrated circuits formed in the same silicon substrate. The respective resistive elements R13 to R18, R111, R112 are formed by thin film resistors or diffusion resistors.

The temperature correcting resistive element Rb comprises a diffusion resistor which is formed in a silicon substrate and uses a base diffusion layer or emitter diffusion layer. The specific resistance of the diffusion resistor is larger in the base diffusion layer than that in the emitter diffusion layer. Therefore, when the resistance value of the temperature correcting resistive element Rb is large, the occupation area on the substrate can be reduced by using the base diffusion layer and thus high integration can be performed.

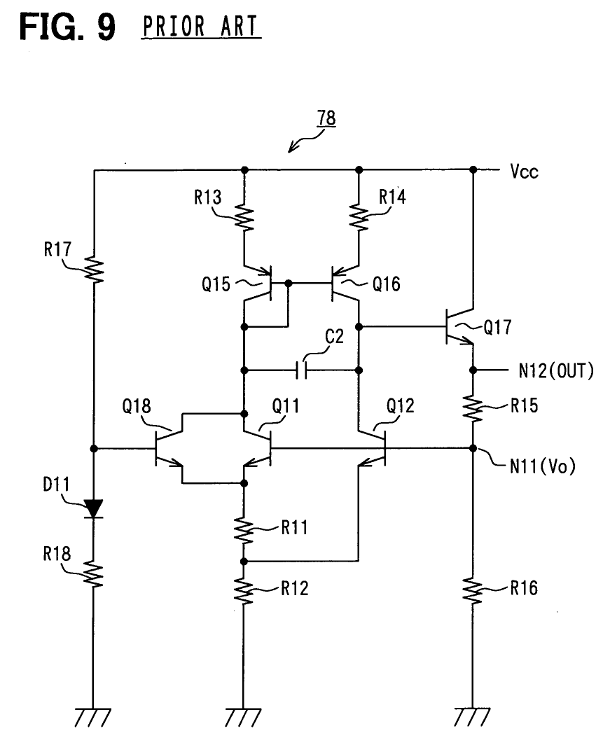

Some of the differences between the band gap constant voltage circuit 71 of the first embodiment and the related art band gap constant voltage circuit 78 shown in FIG. 9 were described above.

(1-1) The resistive element R11 is replaced by the resistive element

(1-2) The resistive element R12 is replaced by the resistive elements R112 and Rb which are connected to each other in series.

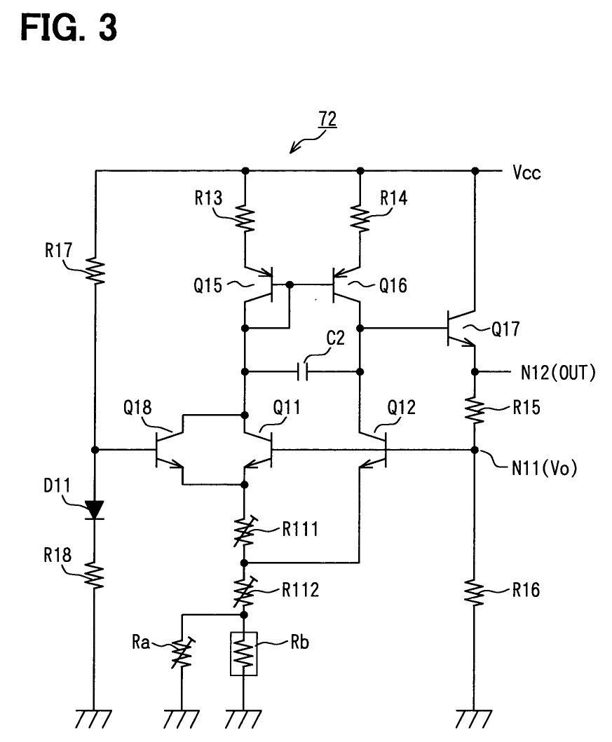

A method of calculating the reference voltage Vo of the band gap constant voltage circuit 71 of the first embodiment is identical to a method of calculating an output voltage Vo′ of the circuit disclosed in FIG. 3 of the Patent Document 1. In this case, it is required to replace “R11” of the equations 1 to 3 of the Patent Document 1 by R111 and replace “R12” by “R112+Rb.” Thus, the specific description thereof is omitted.

According to the first embodiment described above, the following action and effect can be achieved.

[1] In the following conditions (A) and (B), the resistance values of the resistive elements R111, R112 and Rb can be calculated on the basis of the resistance values of the resistive elements R11 and R12 of the related art band gap constant voltage circuit 78 shown in FIG. 9 from the following equations 11 to 13.

(A) A case where the resistive elements R111, R112 are formed of thin film resistors, and the resistance temperature coefficient and the temperature non-linearity are equal to zero (≅0).

(B) A case where the temperature correcting resistive element Rb is formed of a diffusion resistor of 1×10¹⁸ in impurity concentration, the resistance temperature coefficient thereof is equal to about 2000 PPM/° C. and the temperature non-linearity is equal to about 6 PPM/° C.
Rb≅(from 0.2 to 0.4)/6×R12 (equation 11)
R112=R12−Rb (equation 12)
R111≅R11×(1+Rb/R12×2000×0.0003) (equation 13)

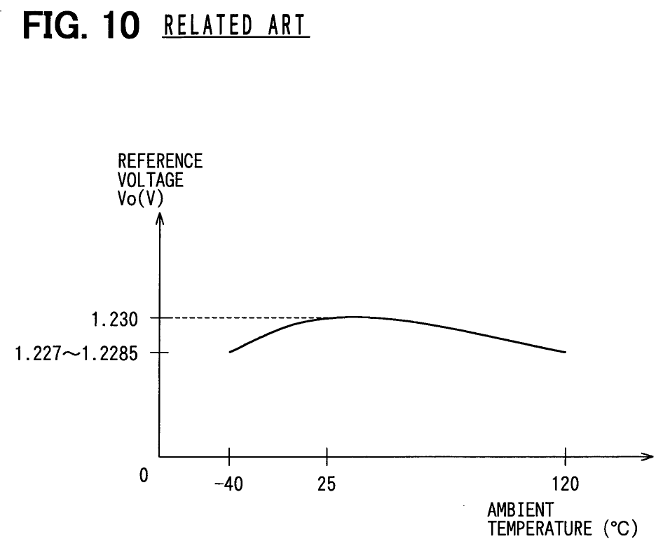

Here, the equation 11 is for calculating the temperature correcting resistive element Rb provided to correct the temperature non-linearity of the band gap constant voltage circuit 71. The numerator “from 0.2 to 0.4” of the equation 11 is a specific value calculated from a measurement value of the temperature non-linearity of the related art band gap constant voltage circuit 78 shown in FIG. 10. The denominator “6” of the equation 11 is a specific value of the temperature non-linearity of the temperature correcting resistive element Rb under the condition (B).

The equation 13 is an equation for calculating the resistive element R111 for correcting the resistance temperature coefficient of the resistive element R11 caused by adding the temperature correcting resistive element Rb. “2000” of the equation 13 is a specific value of the resistance temperature coefficient of the temperature correcting resistive element Rb. “0.0003” of the equation 13 is a proportionality constant (° C./PPM) and it is based on the assumption of use at room temperature of 25° C.

[2] Under the following conditions (C) and (D), the resistance values of the resistive elements R111, R112, Rb can be calculated on the basis of the resistance values of the resistive elements R11 and R12 of the related art band gap constant voltage circuit 78 shown in FIG. 9 from the following equations 14 to 16.

(C) A case where each of the resistive elements R111, R112 is formed of a diffusion resistor having a predetermined impurity concentration, the resistance temperature coefficient thereof is equal to α PPM/° C. and the temperature non-linearity is equal to γ PPM/° C.

(D) A case where the temperature correcting resistive element Rb is formed of a diffusion resistor having a predetermined impurity concentration, the resistance temperature coefficient is equal to β PPM/° C. and the temperature non-linearity is equal to δ PPM/° C. In order to set the conditions (C) and (D), a suitable difference may be provided between the impurity concentration of each of the resistive elements R111, R112 and the impurity concentration of the temperature correcting resistive element Rb.
Rb≅(from 0.2 to 0.4)/(δ−γ)×R12 (equation 14)
R112=R12−Rb (equation 15)
R111=R11×(1+Rb/R12×(β−+)×(Ta+273.15)/10⁶) (equation 16)

Here, in the case of temperature non-linearity in which the reference voltage Vo of the related art band gap constant voltage circuit 78 decreases at a low temperature side and at a high temperature side as shown in FIG. 10, it is required to set the impurity concentration of each of the resistive elements R111, R112, Rb so that the temperature non-linearity 6 is larger than the temperature non-linearity γ (δ>γ). In the case of temperature non-linearity in which the reference voltage Vo increases at the low temperature side and at the high temperature side, it is required to set the impurity concentration of each of the resistive elements R111, R112 and Rb so that the temperature non-linearity γ is larger than the temperature non-linearity δ (γ>δ).

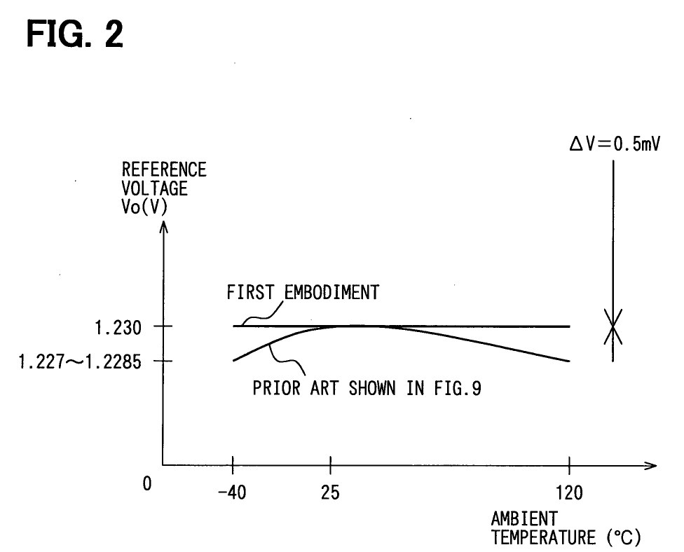

Ta (° C.) of the equation 16 represents center temperature under an environment in which the band gap constant voltage circuit 71 is used. “273.15” of the equation 16 is a constant achieved by converting Ta (Celsius) to absolute temperature (Kelvin).

[3] FIG. 2 is a graph showing the temperature non-linearity of each of the reference voltage Vo of the related art band gap constant voltage circuit 78 shown in FIG. 9 and the reference voltage Vo of the band gap constant voltage circuit 71 of the first embodiment. In this embodiment, the temperature variation ΔV of the reference voltage Vo when the ambient temperature of the circuit varies between −40° C. and 120° C. is equal to about 0.5 mV, and thus the temperature variation of the reference voltage Vo can be reduced by about ⅓ to ⅙.

That is, the band gap constant voltage circuit 71 of the first embodiment is equipped with first and second bipolar transistors Q11, Q12, a current mirror circuit (transistors Q15, Q16) for equalizing the collector current between the transistors Q11, Q12, and a resistive element R112 for setting the collector current of each of the transistors Q11, Q12, and a constant voltage serving as a reference voltage Vo is generated from the commonly-connected bases of the transistors Q11, Q12 on the basis of the band gap constant based on the pn junction between the base and emitter of each of the transistors Q11, Q12. A temperature correcting resistive element Rb having temperature non-linearity which offsets the temperature non-linearity of the reference voltage Vo is connected to the resistive element R112 in series.

Accordingly, in the first embodiment, the temperature non-linearity of the reference voltage Vo in a broad temperature range can be improved by suitably setting the temperature non-linearity of the temperature correcting resistive element. Furthermore, the temperature correcting resistive element Rb which can surely correct the temperature non-linearity of the reference voltage Vo can be easily achieved by implementing the temperature correcting resistive element Rb with a diffusion resistor formed in the same substrate as the transistors Q11, Q12.

### Second Embodiment

FIG. 3 is a circuit diagram showing the construction of a band gap constant voltage circuit 72 according to the second embodiment. The band gap constant voltage circuit 72 has the following different points from the band gap constant voltage circuit 71 according to the first embodiment.

(2-1) The resistive elements R111, R112 are formed of thin film resistors which can be trimmed by a laser.

(2-2) A resistive element Ra is connected to the temperature correcting resistive element Rb in parallel. The resistive element Ra is formed by a thin film resistor which can be trimmed by a laser.

Accordingly, according to the second embodiment, in addition to the action/effect of the first embodiment, a laser beam is irradiated to the thin film resistors constituting the respective resistive elements R111, R112, Ra to cut the thin film resistors, thereby adjusting the resistive values thereof, so that the temperature non-linearity of the band gap constant voltage circuit 72 can be suitably set to a desired value.

### Third Embodiment

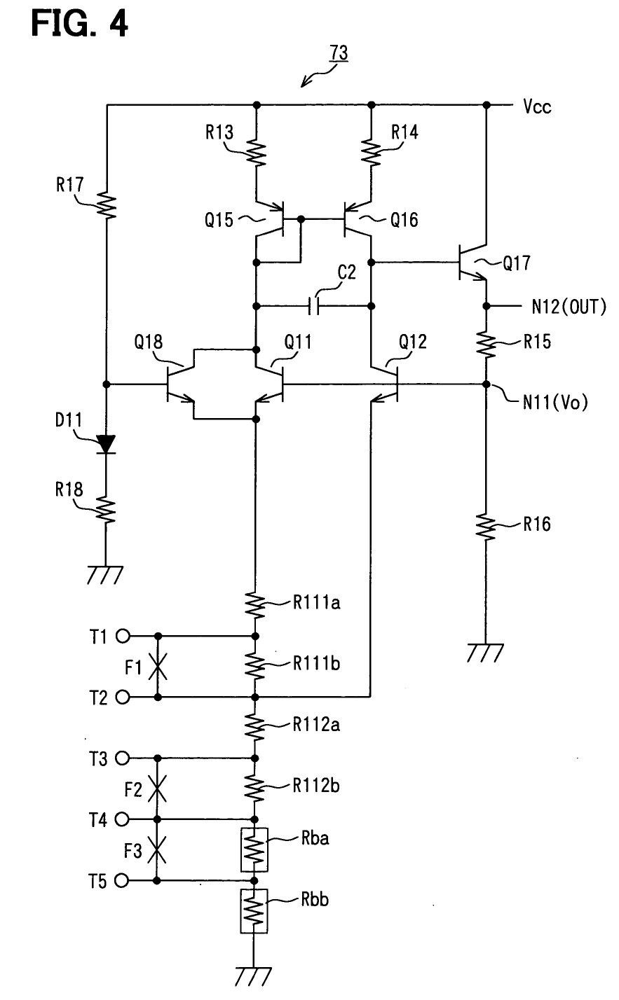

FIG. 4 is a circuit diagram showing the construction of a band gap constant voltage circuit 73 according to a third embodiment. The band gap constant voltage circuit 73 has the following different points from the band gap constant voltage circuit 71 of the first embodiment.

(3-1) The resistive element R111 is replaced by resistive elements R111a and R111b which are connected to each other in series.

(3-2) The resistive element R112 is replaced by the resistive elements R112a and R112b which are connected to each other in series.

(3-3) The temperature correcting resistive element Rb is replaced by temperature correcting resistive elements Rba and Rbb which are connected to each other in series.

(3-4) The resistive element R111b is connected to a fuse element F1 in parallel. External terminals T1 and T2 are connected to both the ends of the fuse element F1. The fuse element F1 can be blown out by making sufficient current flow between the external terminals T1 and T2. The composite resistance value of the resistive elements R111a and R111b is equal to R111a when the fuse element F1 is conductive, and the composite resistance value of the resistive elements R111a and R111b is equal to (R111a+R111b) when the fuse element F1 is blown out.

(3-5) A fuse element F2 is connected to the resistive element R112b in parallel. External terminals T3 and T4 are connected to both the ends of the fuse element F2. The fuse element F2 can be blown out by making sufficient current flow between the external terminals T3 and T4. The composite resistance value of the resistive elements R112a and R112b is equal to R112a when the fuse element F2 is conducted, and the composite resistance value of the resistive elements R112a and R112b is equal to (R112a+R112b) when the fuse element F2 is blown out.

(3-6) A fuse element F3 is connected to the temperature correcting resistive element Rba in parallel. External terminals T4 and T5 are connected to both the ends of the fuse element F3. By making sufficient current flow between the external terminals T4 and T5, the fuse element F3 can be blown out. The composite resistance value of the resistive elements Rba and Rbb is equal to Rbb when the fuse element F3 is conducted, and the composite resistance value of the resistive elements Rba and Rbb is equal to (Rba+Rbb) when the fuse element F3 is blown out.

Accordingly, according to a third embodiment, in addition to the action/effect of the first embodiment, the composite resistance value of the resistive elements R111a, R111b, R112a, R112b, Rba, Rbb is adjusted by selecting the conduction or blow-out of each of the fuse elements F1 to F3, whereby the temperature non-linearity of the band gap constant voltage circuit 73 can be suitably set to a desired value.

In the third embodiment, the temperature correcting resistive element Rb is replaced by the two temperature correcting resistive elements Rba, Rbb which are connected to each other in series, and the composite resistance value thereof is set on the basis of the conduction/blow-out of the fuse element F3. However, the temperature correcting resistive element Rb may be replaced by three or more temperature correcting resistive elements which are connected to one another in series, and also the composite resistance value thereof may be set on the basis of the conduction/blow-out of the two or more fuse elements. In this case, if the composite resistance value is set to be equal to a power of 2 with respect to the minimum set value, the temperature non-linearity of the band gap constant voltage circuit could be minutely adjusted in a broad temperature range.

### Fourth Embodiment

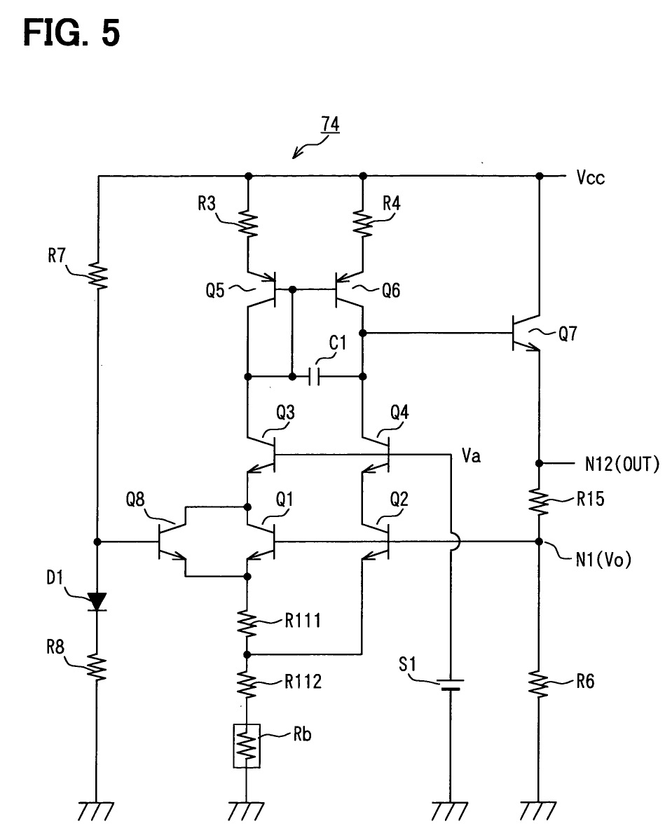

FIG. 5 is a circuit diagram showing the construction of a band gap constant voltage circuit 74 according to a fourth embodiment. The band gap constant voltage circuit 74 is achieved by applying the present invention to the band gap constant voltage circuit disclosed in FIG. 1 of the Patent Document 1. The same constituent elements as the Patent Document 1 (FIG. 1) are represented by the same reference numerals.

The band gap constant voltage circuit 74 of the fourth embodiment comprises resistive elements R3 to R8, R111, R112, npn type bipolar transistors Q1 to Q4, Q7, Q8, pnp type bipolar transistors Q5, Q6, a diode D1, a capacitor C1, a constant voltage source S1, and a temperature correcting resistive element Rb, and it is connected to a positive side power supply (not shown) to be supplied with power supply potential Vcc, so that a voltage at a node N1 is set to a constant voltage serving as a reference voltage Vo. The reference voltage Vo is subjected to resistance division by resistors R15 and R6 to achieve a desired constant voltage at a node N12, and the desired constant voltage (OUT) at the node N12 is output to the external.

The band gap constant voltage circuit 74 of the fourth embodiment has the following different points from the band gap constant voltage circuit disclosed in FIG. 1 of the Patent Document 1.

(4-1) The resistive element R1 is replaced by the resistive element R111.

(4-2) The resistive element R2 is replaced by the resistive elements R112 and Rb which are connected to each other in series. A method of setting the resistance values of the resistive elements R111, R112 and Rb of the fourth embodiment is the same as the first embodiment.

That is, the band gap constant voltage circuit 74 of the fourth embodiment has first and second bipolar transistors Q1 and Q2 whose bases are commonly connected to each other, and bipolar transistors Q5 and Q6 which constitute a current mirror circuit connected to the transistors Q1 and Q2 and to which the power supply potential Vcc is applied, and it generates a reference voltage Vo in association with a base-emitter voltage of each of the transistors Q1, Q2. In the band gap constant voltage circuit thus constructed, third and fourth bipolar transistors Q3 and Q4 which are cascade-connected between the transistors Q1, Q2 and the current mirror circuit and serve to bias the collector voltage of each of the transistors Q1 and Q2 to a constant voltage, and the temperature correcting resistive element Rb is connected in series to the resistive element R112 through which the collector current of each of the transistors Q1, Q2 flows. A constant voltage source S1 for applying a constant bias voltage to the base of each of the transistors Q3 and Q4 is equipped to the base of each of the transistors Q3 and Q4.

Therefore, according to the fourth embodiment, in addition to the action/effect of the first embodiment, the action/effect of the Patent Document 1 (since the transistors Q3 and Q4 are equipped, the collector voltage of each of the transistors Q1 and Q2 is kept constant, and thus variation of the band gap voltage when the power supply potential supplied to the current mirror circuit is varied is suppressed, so that a stable reference voltage Vo can be generated) can be also achieved.

### Fifth Embodiment

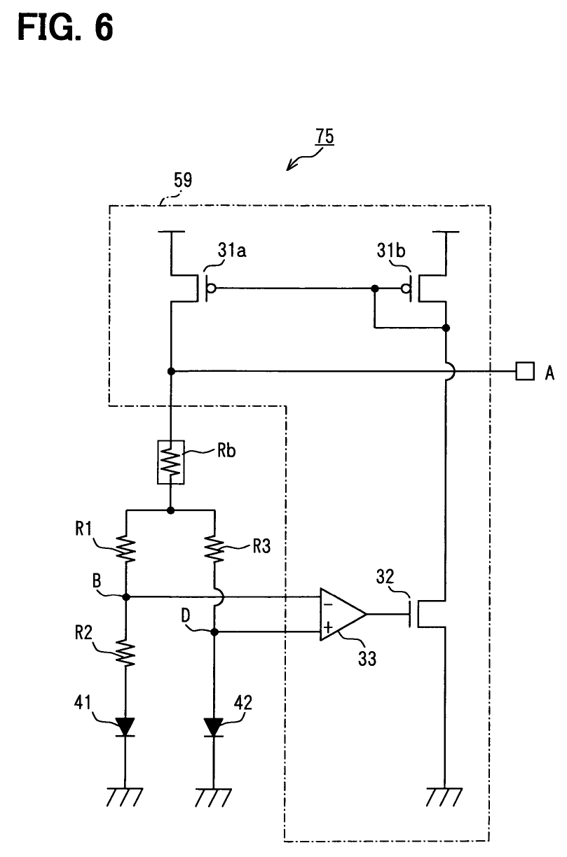

FIG. 6 is a circuit diagram showing the construction of a band gap constant voltage circuit 75 of a fifth embodiment. The band gap constant voltage circuit 75 is achieved by applying the present invention to the band gap constant voltage circuit disclosed in FIG. 13 of the Patent Document 2, and the same constituent elements as the Patent Document 2 (FIG. 13) are represented by the same reference numerals.

The band gap constant voltage circuit 75 of the fifth embodiment comprises diodes 41 and 42, resistors R1, R2 and R3, a feedback circuit 59, and a temperature correcting resistive element Rb, and the voltage at a first terminal A is output as a reference voltage to the external. The feedback circuit 59 comprises PMOS transistors 31a and 31b, an NMOS transistor 32 and a differential amplification circuit 33, and it has a function of controlling the voltage of the first terminal so that the potential of an anode terminal D of the diode 42 is equal to the potential of a second terminal B.

That is, the band gap constant voltage circuit 75 of the fifth embodiment is different from the band gap constant voltage circuit disclosed in FIG. 13 of the Patent Document 2 in that a temperature correcting resistive element Rb is inserted between a first terminal (output terminal) A and each of the resistors R1, R3.

That is, the band gap constant voltage circuit 75 of the fifth embodiment comprises a temperature correcting resistive element Rb connected to the first terminal A, first and second diodes 42 and 41 whose cathode terminals are connected to a ground terminal, a first resistor R3 connected to the first terminal A through the anode terminal of the first diode and the temperature correcting resistive element Rb, a third resistor R2 connected to the anode terminal and a second terminal B of the second diode 41, the second resistor R1 connected to the first terminal A through the second terminal B and the temperature correcting resistive element Rb, and a feedback circuit 59 for controlling the voltage of the first terminal A so that the potential of the anode terminal of the first diode 42 is equal to the potential of the second terminal B.

The band gap constant voltage circuit 75 of the fifth embodiment generates a constant voltage serving as a reference voltage from a band gap voltage based on the pn junction between the cathode and anode of the diodes 41, 42. In the band gap constant voltage circuit 75 of the fifth embodiment, the temperature correcting resistive element Rb formed of a diffusion resistor having temperature non-linearity which offsets the temperature non-linearity of the reference voltage is connected to each of the resistors R1, R3 for setting current flowing through the diodes 41 and 42 in series. Therefore, by suitably setting the temperature non-linearity of the temperature correcting resistive element Rb, the temperature non-linearity of the reference voltage in a broad temperature range can be improved.

### Sixth Embodiment

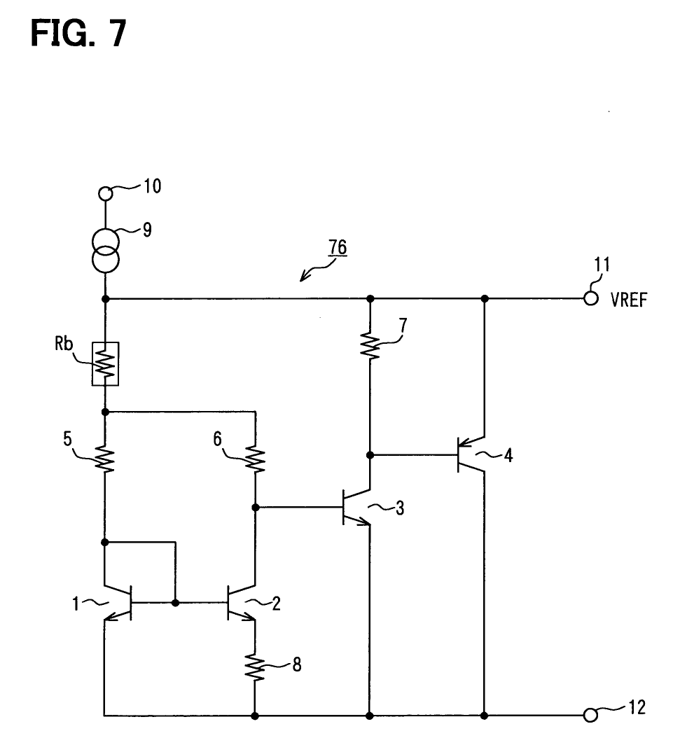

FIG. 7 is a circuit diagram showing the construction of a band gap constant voltage circuit 76 of a sixth embodiment. The band gap constant circuit 76 is achieved by applying the present invention to the band gap constant voltage circuit disclosed in FIG. 3 of the Patent Document 3, and the same constituent elements as the Patent Document 3 (FIG. 3) are represented by the same reference numerals.

The band gap constant voltage circuit 76 of the sixth embodiment comprises NPN transistors 1 to 3, a PNP transistor 4, resistors 5 to 8, a constant current source 9, a positive side power supply terminal 10, an output terminal 11, a ground side power supply terminal 12 and a temperature correcting resistive element Rb, and a voltage VREF at the output terminal 11 is output as a reference voltage to the external.

The band gap constant voltage circuit 76 of the sixth embodiment is different from the band gap constant voltage circuit disclosed in FIG. 3 of the Patent Document 3 in that the temperature correcting resistive element Rb is inserted between the output terminal 11 and each of the resistors 5 and 6.

That is, the band gap constant voltage circuit 76 of the sixth embodiment is equipped with the temperature correcting resistive element Rb connected to the output terminal 11, the first transistor 1 whose collector and base are connected to each other, a second transistor 2 having an emitter area of an integer time of that of the first transistor, the base thereof being connected to the base of the first transistor 1 while the emitter thereof is connected to the ground side power supply terminal 12 through the first resistor 8, a third transistor 3 whose base is connected to the collector of the second transistor 2, a second resistor 6 which is connected to the collector of the second transistor 2 and also to the output terminal 11 through the temperature correcting resistive element Rb, and a third resistor 5 which is connected to the collector of the first transistor 1 and also to the output terminal 11 through the temperature correcting resistive element Rb. The emitter of the first transistor 1 is connected to the ground side power supply terminal 12, and the emitter of the third transistor 3 is connected to the ground side power supply terminal 12.

That is, the band gap constant voltage circuit 76 of the sixth embodiment generates a constant voltage serving as a reference voltage on the basis of the band gap voltage based on the pn junction between the base and emitter of each of the transistors 1 and 2. In the band gap constant voltage circuit 76 of the sixth embodiment, the temperature correcting resistive element Rb formed of a diffusion resistor having temperature non-linearity which offsets (corrects) the temperature non-linearity of the reference voltage is connected in series to each of the resistors 5 and 6 for setting current flowing in each of the transistors 1 and 2. Therefore, by suitably setting the temperature non-linearity of the temperature correcting resistive element Rb, the temperature non-linearity of the reference voltage in a broad temperature range can be improved.

### Seventh Embodiment

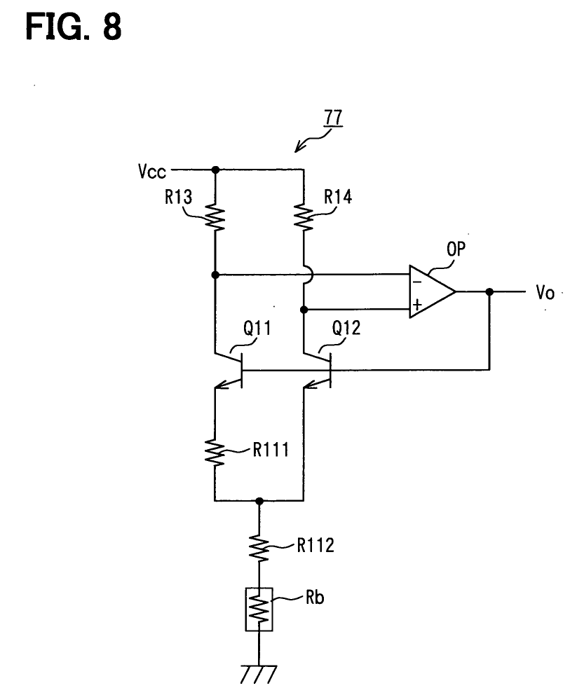

FIG. 8 is a circuit diagram showing the construction of a band gap constant voltage circuit 77 of a seventh embodiment. The band gap constant voltage circuit 77 comprises resistive elements R13, R14, R111, R112, npn type bipolar transistors Q11, Q12, a differential amplification circuit OP, and a temperature correcting resistive element Rb. It is connected to a positive side power supply (not shown) to be supplied with a power supply potential Vcc, and the voltage at the gate of each of the transistors Q11, Q12 and the output terminal of the differential amplification circuit OP is output as a reference voltage Vo to the external.

The band gap constant voltage circuit 77 of the seventh embodiment is different from the band gap constant voltage circuit 71 of the first embodiment in the following points.

(7-1) The start-up circuit (the resistive elements R17 and R18, the diode D11, the transistor Q18), each of the transistors Q15 to Q17, the capacitor C2 and the resistive elements R15 and R16 are omitted.

(7-2) The collector of each of the transistors Q11 and Q12 is connected to an input terminal of the differential amplification circuit OP.

The method of setting the resistance values of the resistive elements R111, R112, Rb in the seventh embodiment is the same as the first embodiment.

That is, according to the band gap constant voltage circuit 77 of the seventh embodiment, in the band gap constant voltage circuit having the first and second bipolar transistors Q11 and Q12 whose bases are commonly connected to each other and in which the reference voltage Vo is generated in connection with the base-emitter voltage of each of the transistors Q11 and Q12, the temperature correcting resistive element Rb is connected in series to the resistive element R112 through which the collector current of each of the transistors Q11 and Q12 flows. Accordingly, according to the seventh embodiment, the same action/effect as the first embodiment can be achieved.

### Other Embodiments

The present invention is not limited to the above embodiments, and various modifications described below may be made to implement the present invention. In this case, the same or more excellent action/effect as or than the above embodiments can be achieved.

(1) The present invention may be applied to the band gap constant voltage circuit disclosed in FIG. 2 of the Patent Document 2, and in this case the action/effect of the Patent Document 2 can be achieved in addition to the action/effect of the present invention.

(2) The present invention may be applied to the band gap constant voltage circuit disclosed in FIG. 1 of the Patent Document 3, and in this case the action/effect of the Patent Document 3 can be achieved in addition to the action/effect of the present invention.

(3) Each of the fourth to seventh embodiments may be used in combination with the second embodiment. That is, in the fourth to seventh embodiments, the temperature non-linearity of the band gap constant voltage circuit may be set to a desired value by equipping a thin film resistor which can be laser-trimmed and cutting the thin film resistor through laser irradiation to adjust the resistance value thereof as in the case of the second embodiment.

(4) Each of the fourth to seventh embodiments may be used in combination with the third embodiment. That is, in the fourth to seventh embodiments, the temperature non-linearity of the band gap constant voltage circuit may be set to a desired value by replacing the temperature correcting resistive element Rb and a prescribed resistive element by plural resistive elements which are connected to one another in series and adjusting the composite resistance value of these resistive elements through conduction/blow-out of the fuse element.

(5) The temperature correcting resistive element Rb of each of the embodiments is not limited to the diffusion resistor, and it may be replaced by any resistive element (for example, a positive characteristic thermistor in which the resistance value thereof increases as the temperature increases) insofar as it has temperature non-linearity (heat-sensitive resistor).

The description of the invention is merely exemplary in nature and, thus, variations that do not depart from the gist of the invention are intended to be within the scope of the invention. Such variations are not to be regarded as a departure from the spirit and scope of the invention.

Regarding the appended claims, “Semiconductor element” corresponds to transistors Q11, Q12 of first to third and seventh embodiments, transistors Q1, Q2 of a fourth embodiment, diodes 41, 42 of a fifth embodiment and transistors 1, 2 of a sixth embodiment. “Current setting resistive element” corresponds resistive elements R112 of first to fourth and seventh embodiments, resistive elements R1, R3 of a fifth embodiment, and resistive elements 5, 6 of a sixth embodiment. “First and second bipolar transistors” correspond to transistors Q11, Q12 of the first embodiment, and transistors Q1, Q2 of the fourth embodiment. “Current mirror circuit” corresponds to transistors Q15, Q16 of the first embodiment and transistors Q5, Q6 of the fourth embodiment. “Adjusting means” corresponds to resistive elements R111, R112, Ra of the second embodiment, resistive elements R111a, R111b, R112a, R112b, Rba, Rbb, fuses F1 to F3 and external terminals T1 to T5.

1. A band gap constant voltage circuit for generating a constant voltage serving as a reference voltage on the basis of a band gap voltage based on a pn junction of a semiconductor element, wherein a temperature correcting resistive element having temperature non-linearity for offsetting a temperature non-linearity of the reference voltage is connected to a current setting resistive element for setting current flowing in the semiconductor element in series.

2. The band gap constant voltage circuit according to claim 1, wherein the temperature correcting resistive element comprises a diffusion resistive element using a diffusion layer formed in the same semiconductor substrate as the semiconductor element or the transistor.

3. The band gap constant voltage circuit according to claim 2, further comprising adjusting means for adjusting resistance values of the current setting resistive element and the temperature correcting resistive element.

4. The band gap constant voltage circuit according to claim 1, further comprising adjusting means for adjusting resistance values of the current setting resistive element and the temperature correcting resistive element.

5. A band gap constant voltage circuit comprising:
first and second bipolar transistors;
a current mirror circuit for equalizing collector current between the first and second bipolar transistors; and
a current setting resistive element for setting the collector current of the first and second bipolar transistors, wherein a constant voltage serves as a reference voltage being generated from commonly-connected bases of the first and second bipolar transistors on the basis of a band gap voltage based on pn junction between the base and emitter of the first and second bipolar transistors, wherein a temperature correcting resistive element having temperature non-linearity which offsets temperature non-linearity of the reference voltage is connected to the current setting resistive element in series.

6. The band gap constant voltage circuit according to claim 5, wherein the temperature correcting resistive element comprises a diffusion resistive element using a diffusion layer formed in the same semiconductor substrate as the semiconductor element or the transistor.

7. The band gap constant voltage circuit according to claim 6, further comprising adjusting means for adjusting resistance values of the current setting resistive element and the temperature correcting resistive element.

8. The band gap constant voltage circuit according to claim 5, further comprising adjusting means for adjusting resistance values of the current setting resistive element and the temperature correcting resistive element.
